(19) United States
(12) Patent Application Publication
(10) Pub. No.: US 2008/0318589 A1
(43) Pub. Date: Dec. 25, 2008

(54) Transmission Optimization in a Wireless Base Station System Based on Load-Sharing

(76) Inventors: Sheng Liu, Guangdong (CN); Baijun Zhao, Guangdong (CN); Huang Bill, Guangdong (CN)

Correspondence Address: GREENBERG TRAURIG, LLP, MET LIFE BUILDING, 200 PARK AVENUE, NEW YORK, NY, 10166, US

(21) Appl. No.: 10/598,521

(22) PCT Filed: Mar. 5, 2004
(86) PCT No.: PCT/CN2004/000179

§ 371 Date: Sep. 3, 2008

(51) Int. Cl. H04Q 7/30

(52) U.S. Cl. 455/453

(57) ABSTRACT

A signal transmission method in a wireless base station system is provided, comprising: in the downlink direction, the wireless network control device transmits downlink data frames of the cell to the base station to which their channel processing relates for processing; the first base station receives corresponding downlink wireless signals from the base station which the channel processing of the cell's downlink data frames relates to; and the first base station transmits the downlink wireless signals for the cell; and in the uplink direction, the first base station receives uplink wireless signals of the cell; the first base station distributes a part or all of the uplink wireless signals to the base station to which their channel processing relates for processing; the wireless network control device receives corresponding uplink data frames from the base station which the channel processing of the uplink wireless signals relates to, wherein the base station which the channel processing of the downlink data frames relates to, or the base station which the channel processing of the uplink wireless signals relates to comprises at least the second base station.

### TECHNICAL FIELD

The present invention relates to the communication, field, and more particularly, relates to the transmission optimization in a wireless base station system based on the load-sharing architecture of a mobile communication system.

### BACKGROUND TECHNOLOGY

In the mobile communication system, the transmission, reception and processing of the wireless signals are performed by base stations (BTS). As shown in FIG. 1a, a conventional BTS is mainly composed by a baseband processing subsystem, a radio frequency (RF) subsystem and an antenna, and one BTS may cover different cells through the RF antenna. As shown in FIG. 1b, BTSs are connected to a base station controller (BSC) or wireless networks controller (RNC) respectively through a certain interface, and in a WCDMA (wideband code division multiple access) system, for example, the interface is Iub interface.

In the traditional BTS system, since the baseband processing subsystem, RF subsystem and antenna are geographically located together, therefore each cell must be equipped with enough channel processing resources to fulfill each cell's peak traffic, and therefore needs a higher cost. To solve this problem, there is proposed a BTS structure with a low coat, a centralized BTS system based on remote antenna units, and more implementation details were disclosed in PCT patent WO9005432 “Communications system”, U.S. Pat. No. 657,374 “Cellular system with centralized base stations and distributed antenna units”, U.S. Pat. No. 6,324,391 “Cellular communication with centralized control and signal processing”, China patent CN1211889 “duplex open air BTS transceiver subsystem using a hybrid system”, and United States Patent application US20030171118 “Cellular radio transmission apparatus and cellular radio transmission method”.

As shown in FIG. 2, existing centralized BTS system 200 based oh remote antenna units are composed of a central channel processing subsystem 21 and remote antenna units 22 which are installed as centralized. The central channel processing subsystem 21 mainly comprises functional units such as channel processing resource pool 23, signal distribution unit 25, line interface unit 26 and etc., wherein the channel processing resource pool is formed by stacking a plurality of channel processing units 24, and performs tasks such as baseband signal processing of cells possessed by the BTS, and the signal distribution unit 25 dynamically distributes channel processing resources according to conditions of actually active users of different cells to realize effective sharing of the processing resources among multiple cells. The remote antenna unit 22 is mainly constituted by the transmission channel's radio frequency power amplifier, the reception channel's low noise amplifier, an antenna and etc. The links between the central channel processing subsystem 21 and the remote antenna units 22 may adopt transmission medium such as optical fiber, coaxial cable, microwave and etc.; the signal transmission may be done by way of digital signals after sampling, or simulating signals after modulating; the signals may be baseband signals, intermediate frequency signals or radio-frequency signals. For technologies for dynamically allocating channel processing resources, please refer to U.S. Pat. No. 6,353,600 “Dynamic sectorization in CDMA employing centralized base-station architecture”, U.S. Pat. No. 6,594,496 “Adaptive capacity management in a centralized base station architecture” and etc.

However, there still exists a certain channel processing resources allocation problem with the technology as described in the above patent documents and the existing centralized base station system adopting remote antenna units. As noted earlier, in the centralized BTS system adopting remote antenna units, since the reusing of the channel processing resources by multiple cells, the actual total amount of the channel processing resources may be less than the total peak traffic of all the cells. For example, a centralized BTS system supports maximal 10 remote antenna units, each of which corresponds to one cell. Suppose that each cell's peak traffic is equivalent to 96 service channels, the total peak traffic of all the cells is equivalent to 960 service channels, in consideration of reuse of the processing resources, the number of the actually configured channel processing units is less than the total peak traffic. Thus, when all the cells in a centralized BTS system reach to a very high traffic, the centralized BTS system's channel processing resources will not be able to fulfill the actual traffic demand, thereby causing call loss which impacts the quality of service.

Although increasing the amount of the centralized BTS system's channel processing resources may reduce the occurrence frequency of this problem, it counteracts the centralized BTS system's advantage of higher resource utilization resulted from the reuse of the channel processing resources by multiple cells, and therefore, to optimize the wireless base station system's resource allocation, there is needed a method which allows for adopting as low as possible configured channel processing resources, and at the same time, is able to avoid call loss caused by inadequate resources.

To solve this problem, the inventors presents a solution which allows for adopting as low as possible configured channel processing resources, and at the same time, is able to avoid call loss caused by inadequate resources. At the same time, the solution's advantages also include the ability to realize high usability of the base station system, i.e., when a part or all of a base station's channel processing resources fail to work, the technology is still able to guarantee the user's access.

FIGS. 3 and 4 show centralized base station systems 300 and 400 supporting processing resource sharing and load-sharing, which are based on the solution. As compared to the conventional base station system, the solution improves signal distribution units 35 and 45, and adds link interfaces 37 and 47 for connecting to other base station(s). Thus, the solution allows the centralized base station system to be configured with less channel processing resources, wherein when a predetermined condition is satisfied (for example, when the channel processing resources' occupation rate reaches to a certain upper limit, or when the channel processing resources are insufficient), the improved signal distribution units 35 and 45 will directly switch a part or all of the signals to the wideband link interface 37 and 47 connected to other base station(s), so that the other remote end base station system(s) can share respective processing loads, thereby avoiding call loss caused by the centralized base station system's, i.e., the local base station's inadequate resources.

That is to say, the inventors propose a new signal distribution manner: a part or all of uplink signals and a part or all of downlink signals are distributed to the local base station and the remote end base station(s) respectively for processing. See FIG. 5a and FIG. 5b. Since there is a certain correspondence between the uplink and the downlink signals, in the signal distribution, a downlink signal corresponding to the uplink signal which has been distributed to the local base station or the remote end base station will be preferably distributed to the base station for processing that uplink signal. The signal distribution manner may be divided into the following two types: 1) as required, all the channel processing jobs of a cell are switched to other base station (a), as shown in FIG. 5a; 2) uplink signals of a cell are distributed to the present base station's uplink processing unit and other base station(s), thereby allowing the local base station and the remote end base station(s) to respectively perform a portion of uplink traffic channel processing of the cell's uplink signals, and allowing the local base station and the remote end base station(s) to respectively perform the downlink traffic channel processing of the cell's downlink signals corresponding to the uplink signals, and the downlink signals are multiplexed as groups of downlink signals in the signal distribution unit according to the way by which they are multiplexed, as shown in FIG. 5b.

According to the inventor's solution, as shown in FIG. 6, besides transmitting the uplink and downlink wireless signals of the cell which are distributed based on the load-sharing, the wideband link between BTS 61 and BTS 62 needs also at least delivery the following three types of information: cell timing synchronization information; downlink data frames from the BSC/RNC, which are forwarded via the local BTS, and uplink data frames returned to the local BTS, which are processed by the remote end BTS; uplink wireless signals from the cell, which are forwarded via the local BTS, and downlink wireless signals returned to the local BTS, which are processed by the remote end BTS; as well as the control information between the local BTS and the remote end BTS. The control information between the BTSs comprises operating commands for performing the resource query, allocation control, establishment, modification, releasing and etc., in order to control the operations of the remote end BTS for sharing the channel processing. The cell timing synchronization information is used for the local BTS and the remote end BTS to achieve frame timing synchronization.

According to the inventor's solution, as shown in FIG. 7, the user plane data/signal transmission routing between BTS 71 and BTS 72 comprises: in the downlink direction, the downlink data frames from BSC/RNC 73 are forwarded to remote end BTS 72 by local BTS 71, are used by remote end BTS 72 to generate a part or all of downlink physic channels of a designated cell and to form baseband or intermediate frequency digital signals, which are transmitted to local BTS 71 via the wideband link between local BTS 71 and remote end BTS 72, and to form down link wireless signals of the cell in local BTS 71, which are sent out through antenna 74; in the uplink direction, uplink wireless signals of a designated cell which are received by antenna 74 are routed to remote end BTS 72 via the signal distribution unit of local BTS 71 and the wideband link, undergoes the baseband processing by remote end BTS 72 to form uplink data frames, which are returned to local BTS 71 by remote end BTS 72 via the wideband link, and finally are transferred to BSC/RNC 73 by local BTS 71. As will be readily seen, since the uplink and downlink data frames both need foe forwarded via local BTS 71, there is an apparent redundancy in the existing data transmission route, causing the increased transmission delay and the waste of transmission resource.

### SUMMARY OF THE INVENTION

An object of the present invention is to provide a signal transmission method in a wireless base station system based on load-sharing, to overcome the above problems.

The present invention provides a signal transmission method in a wireless base station system, said wireless base station system comprising a first base station, a second base station and a wireless networks control device, wherein the first base station and the second base station are able to jointly share channel processing task of a cell of the first base station, the method comprising: in the downlink direction, transmitting by the wireless network control device a part or all of downlink data frames to the base station to which their channel processing relates for processing; receiving by the first base station corresponding downlink wireless signals from the base station which the channel processing of the cell's downlink data frames relates to; and transmitting by the first base station the downlink wireless signals for the cell; and in the uplink direction, receiving by the first base station uplink wireless signals of the cell; distributing by the first base station a part or all of the uplink wireless signals to the base station to which their channel processing relates for processing; receiving by the wireless network control device corresponding uplink data frames from the base station which the channel processing of the uplink wireless signals relates to; wherein the base Station which the channel processing of the downlink data frames relates to, or the base station which the channel processing of the uplink wireless signals relates to comprises at least the second base station.

### DESCRIPTION OF THE DRAWINGS

The above and/or other aspects, features and/or advantages of the present invention will be further appreciated in view of the following description in conjunction with the accompanying FIGS., wherein:

FIG. 1a is a diagram showing the structure of a conventional base station system;

FIG. 1b is a diagram showing the conventional network structure of the BTS and BSC/RNC;

FIG. 2 is a diagram showing the structure of a centralized base station system adopting remote end antenna units;

FIG. 3 is a diagram showing the structure of a centralized base station system supporting processing resource sharing and load-sharing;

FIG. 4 is a diagram showing the structure of a conventional base station system supporting processing resource sharing and load-sharing;

FIG. 5a is a diagram showing an uplink and downlink signal distributing manners of the present invention;

FIG. 5b is a diagram showing an uplink and downlink signal distributing manner of the present invention;

FIG. 6 is a diagram showing the information transmission between BTS interfaces based on load-sharing;

FIG. 7 is a diagram showing user plane data/signal flow of a existing BTS based on load-sharing;

FIG. 8 is a diagram showing user plane transmission optimization when adopting the signal distribution manner as shown in FIG. 5a;

FIG. 9 is a diagram showing user plane transmission optimization when adopting the signal distribution manner as shown in FIG. 5b.

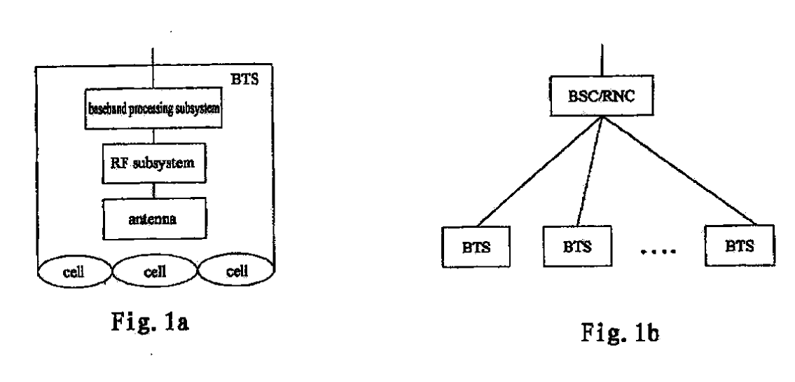

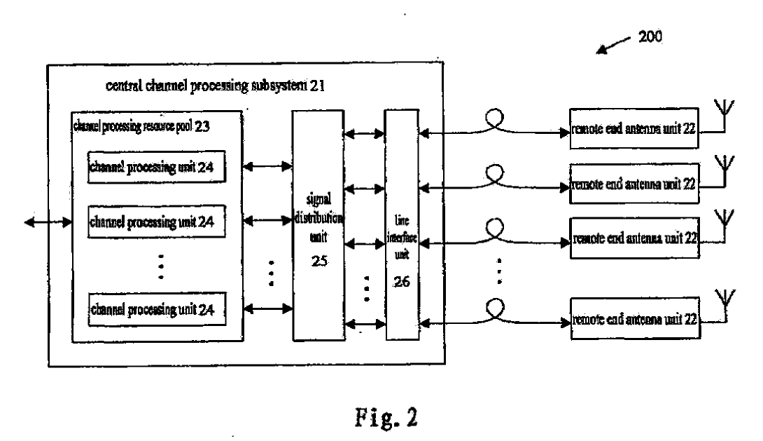

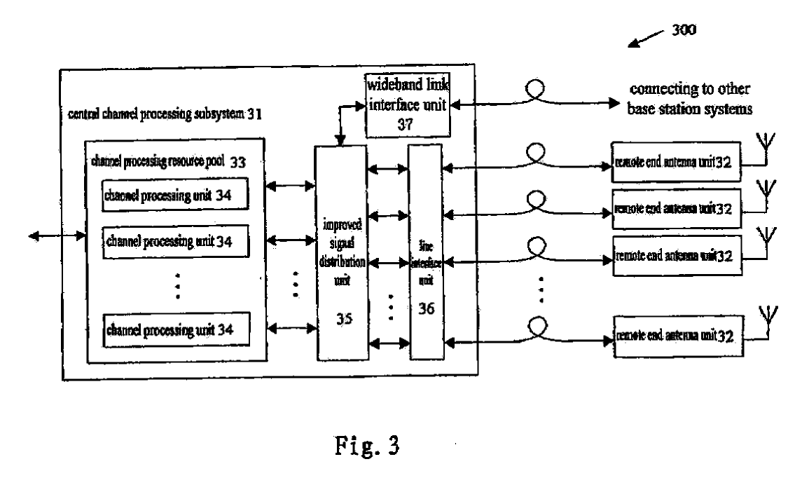

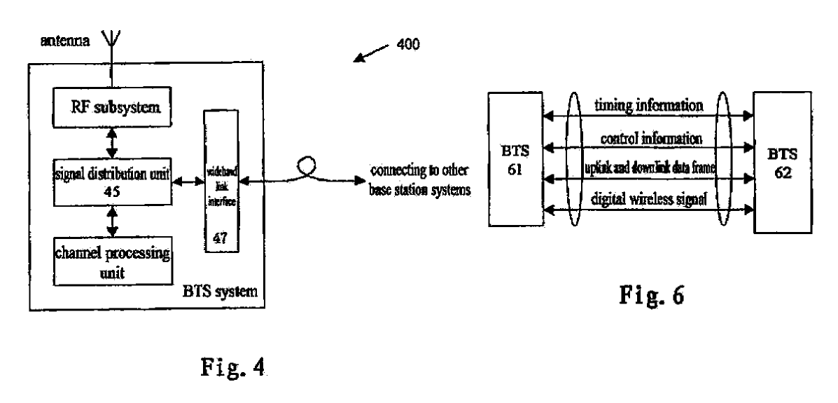

### DETAILED DESCRIPTION OF THE PREFERRED EMBODIMENTS

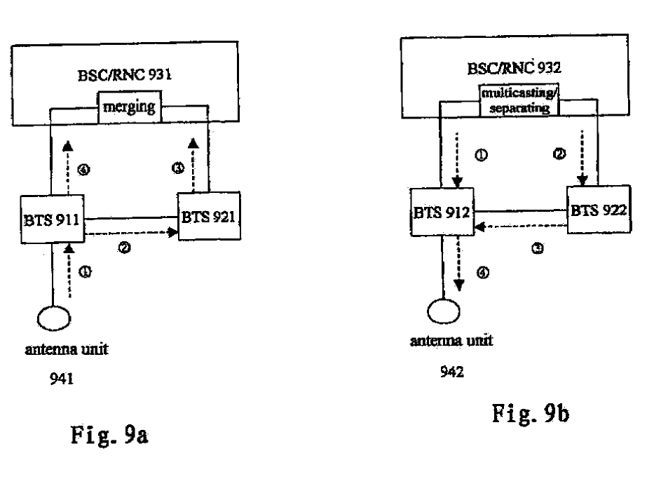

A method of the present invention will be specifically described by referring to FIGS. 8 and 9.

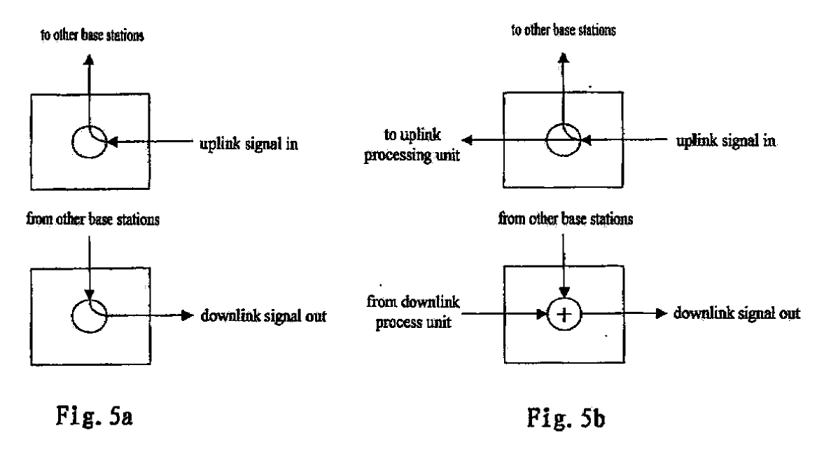

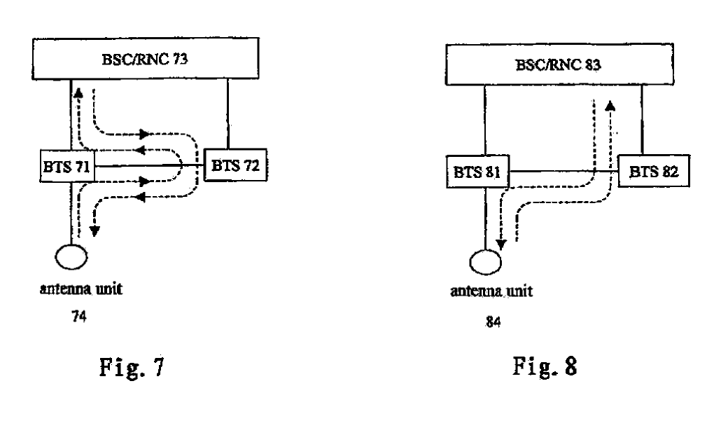

According to the present invention, as shown in FIG. 87 when local BTS 81 applies the signal distribution manner as shown in FIG. 5a because of processing resource insufficiency or according to other distribution policies (for example, load balancing or fixed distribution and ao on), for transmission optimization, in the user plane, the system transfers or copies the cell's configuration information maintained by local BTS 81, as well as configuration information of already established common and private channels of the cell to remote and BTS 82. Local BTS 81 will not in charge of user plane protocol processing relating to the cell with BSC/RNC 83, and remote end BTS 82 directly performs user plane data transmission and corresponding user plane protocol processing with BSC/RNC 83. Thus, the system will establish a new routing relation among local BTS, remote end BTS 82 and BSC/RNC 83.

One skilled in the art will understand that, in the system, it is possible to obtain the configuration about the channel processing distribution of local and remote end BTSs participating in the cell's channel processing for example through report, query or identification and so on. In one preferable embodiment, the configuration may be dynamically changed. In another preferable embodiment, information about the configuration may be stored at any accessible location in the system and may be dynamically updated in the event of change.

In the uplink direction, the cell's uplink signals may be transmitted to remote end BTS 82 through the wideband link via local BTS 81, to perform processing of uplink traffic channels. The cell's uplink data frames formed by the channel processing of remote end BTS 82 will not be returned to local BTS 81, but directly transmitted to BSC/RNC 83 by remote end BTS 82. Here, BSC/RNC 83 will receive the cell's uplink data frames from remote end BTS 82 rather than local BTS 81. In addition, and alternatively, in the downlink direction, BSC/RNC 83 may no longer transmit down link data frames belonging to the cell to local BTS 81, but instead directly transmits them to remote end BTS 82. After remote end BTS 82 completes the cell's downlink channel processing, the formed downlink wireless signals are further transmitted to local BTS 81 through the wideband interface between BTSs.

According to the present invention, as shown in FIG. 9, when the local BTS applies the signal distribution manner as shown in FIG. 5b because of processing resource insufficiency or according to other distribution policies (for example, load balancing or fixed distribution and so on), for transmission optimization, in the user plane, the system transfers or copies the cell's configuration information maintained by the local BTS, as well as configuration information of common and private channels allocated to the remote end BTS for performing corresponding channel processing in the cell to the remote end BTS, thereby allowing the remote end BTS to perform direct transmission of the user plane data and corresponding user plane protocol processing with the BSC/RNC. Thus, the system will create a new routing relation among the local BTS, the remote end BTS and the BSC/RNC.

One skilled in the art will understand that, in the system, it is possible to obtain the configuration about the channel processing distribution of local and remote end BTSs participating in the cell's channel processing for example through report, query or identification and so on. In one preferable embodiment, the configuration may be embodiment changed. In another preferable embodiment, information about the configuration may be stored at any accessible location in the system and may be dynamically updated in the event of change.

As shown in FIG. 9a, in the uplink direction, the cell's uplink signals may be transmitted to remote end BTS 921 through the wideband link via local BTS 911, to perform processing of uplink traffic channels. A part of the cell's uplink data frames formed by the channel processing of remote end BTS 921 will not be returned to local BTS 911, but directly transmitted to BSC/RNC 931 by remote end BTS 921. Here, BSC/RNC 931 will receive the cell's uplink data frames from remote end BTS 911 and remote end BTS 921 at the same time. Therefore, BSC/RNC 931 needs to have a function of “merging” uplink data frames of the same cell from different BTSs. Here, “merging” means that the BSC/RNC is able to correctly recognize all the uplink data frames belonging to the cell and perform corresponding processing. In one preferable embodiment, the BSC/RNC performs this recognition according to the configuration information.

In addition, and alternatively, as shown in FIG. 9b, for example in the downlink direction, BSC/RNC 932 may transmit each down link data frame belonging to the cell to corresponding local BTS 912 and remote end BTS 922 through “separating” or multicasting (multicast), to perform corresponding downlink channel processing respectively by local BTS 912 and remote end BTS 922, wherein downlink signals formed through processing of remote end BTS 922 are all transmitted to local BTS 912 through the wideband interface between BTSs, and finally local BTS 912 performs merging to form the cell's downlink wireless signals. Here, “separating” means that the BSC/RNC is able to discriminate corresponding channel's down link data frames according to the local BTS and remote end BTS's signal distribution (for example, according to the obtained configuration information), and respectively transmit them to corresponding BTSs. Here, multicasting means that the BSC/RNC simply transmit all down link data frames of the cell to all the BTSs participating in the cell's channel processing.

The two kinds of procedures for purpose of transmission optimization may be initiated by the BSC/RNC, or by one of the local BTS, the remote end BTS and the third party BTS, or by negotiation between BTSs. All the configuration information relating to the cell and the context information of already established common and private channels in the cell, which are maintained by the local BTS, may typically be transferred through the wideband interface between the local BTS and the remote end BTS, and may also be transferred through the interface between the BTS and the BSC/RNC via BSC/RNC.

In order to guarantee that in the above two kinds of procedures, the cell is able to perform a continual communication without interruption and not to be influenced by the change in the control plane and user plane data routing of the interface between the BTS and the BSC/RNC and the transit of corresponding protocol processing entities, necessary synchronization should be kept between the local BTS and the remote end BTS in the switching procedure. According to the present invention, a preferable method is to determine a timing at which the local BTS, the remote end BTS and the BSC/RNC perform the switching at the same time, thereby realizing synchronous switching in the above procedures.

Although the present invention has been described according to preferable embodiments, but these descriptions are only for purpose of explaining the present invention, and should not be construed as any limitation on the present invention. For example, although only one remote end BTS is shown for simplicity, there can be a plurality of remote end BTSs to share the local BTS's channel processing load. One skilled in the art can perform various possible modifications and improvements on the present invention, and these modifications and improvements are intended to be included in the scope and spirit of the present invention as defined by the appended claims.

1. A signal transmission method in a wireless base station system, said wireless base station system comprising a first base station, a second base station and a wireless networks control device, wherein the first base station and the second base station are able to jointly share channel processing task of a cell of the first base station, the method comprising:
in the downlink direction,
transmitting by the wireless network control device a part or all of downlink data frames to the base station to which their channel processing relates for processing;
receiving by the first base station Corresponding downlink wireless signals from the base station which the channel processing of the cell's downlink data frames relates to; and
transmitting by the first base station the downlink wireless signals for the cell; and
in the uplink direction,
receiving by the first base station uplink wireless signals of the cell;
distributing by the first base station a part or all of the uplink wireless signals to the base station to which their channel processing relates for processing;
receiving by the wireless network control device corresponding uplink data frames from the base station which the channel processing of the cell's uplink wireless signal relates to;
wherein the base station which the channel processing of the downlink data frames relates to, or the base station which the channel processing of the uplink wireless signals relates to comprises at least the second base station.

2. The method of claim 1, further comprising a step of transmitting channel configuration information in the cell from the first base station to the second base station sharing the channel processing task.

3. The method of claim 1, wherein the base station which the channel processing of the downlink data frames relates to and the base station which the channel processing of the uplink wireless signals relates to both comprise the second base station.

4. The method of claim 1, wherein the second base station comprise more than one base stations.

5. The method of claim 1, further comprising a step of:
when the base station which the channel processing of the uplink wireless signals relates to comprises more than one base stations, the uplink data frames belonging to the same cell are merged into one flow of uplink data of the cell in the wireless network control device.

6. The method of claim 1, further comprising a step of:
when the base station which the channel processing of the downlink data frames relates to comprises more than one base stations, the downlink data frames are separated in the wireless network control device in order to be transmitted to corresponding base stations.

7. The method of claim 1, further comprising a step of:
when the base station which the channel processing of the downlink data frames relates to comprises more than one base stations, the wireless network control device transmit the same downlink data frames to the base stations.

8. The method of claim 1, further comprising a step of:
when the base station which the channel processing of the downlink data frames relates to, the base station which the channel processing of the uplink wireless signals relates to, or the channel processing task shared by the base station changes, signaling is applied to perform synchronous switching between the base station and the wireless network control device.

9. The method of claim 1, further comprising a step of:
providing configuration information to indicate the correspondence between the base station and the cell channel processing task shared by it.
